(19) United States
(12) Patent Application Publication
(10) Pub. No.: US 2010/0146534 A1
(43) Pub. Date: Jun. 10, 2010

(54) System and Method to Authenticate a Set-Top Box Device

(75) Inventors: Wenge Chen, Austin, TX (US); Christopher J. Chase, Austin, TX (US); Kuo-Hui Liu, San Ramon, CA (US)

Correspondence Address: AT & T LEGAL DEPARTMENT - Toler;ATTN: PATENT DOCKETING, ROOM 2A-207, ONE AT & T WAY, BEDMINISTER, NJ, 07921, US

(73) Assignee: AT&T Intellectual Property I, L.P., Reno, NV (US)

(21) Appl. No.: 12/331,126

(22) Filed: Dec. 9, 2008

(51) Int. Cl. H04N 7/16; H04N 7/18

(52) U.S. Cl. 725/25; 725/82

(57) ABSTRACT

A method includes receiving, at a residential gateway, an authentication request from a set-top box device. The method includes accessing authentication data stored at a memory of the residential gateway. The authentication data is associated with the set-top box device. The method also includes authenticating the set-top box device at the residential gateway based at least partially on the authentication data.

### FIELD OF THE DISCLOSURE

The present disclosure is generally related to authenticating a set-top box device.

### BACKGROUND

In a multimedia delivery network, such as a television network, an Internet Protocol Television (IPTV) network, or a satellite television network, set-top box devices may be authenticated by a centrally located authentication system. For example, a set-top box device may request authentication when the set-top box device is initially connected to the network or when the set-top box device is rebooted. When many set-top box devices are rebooted, such as after a power outage or following a firmware upgrade, the authentication system may become overwhelmed with authentication requests resulting in increased processing time and delay in responding to authentication requests.

### BRIEF DESCRIPTION OF THE DRAWINGS

FIG. 1 is a block diagram of a first particular embodiment of a system to authenticate a set-top box device;

FIG. 2 is a block diagram of a second particular embodiment of a system to authenticate a set-top box device;

FIG. 3 is a flow diagram of a first particular embodiment of a method to authenticate a set-top box device;

FIG. 4 is a flow diagram of a second particular embodiment of a method to authenticate a set-top box device; and

FIG. 5 is a block diagram of an illustrative embodiment of a general computer system.

### DETAILED DESCRIPTION

In a particular embodiment, a system includes a service provisioning system to send authentication data to a residential gateway. The authentication data is to be stored at the residential gateway to enable the residential gateway to authenticate one or more set-top box devices associated with the residential gateway. Authenticating the one or more set-top box devices enables the one or more set-top box devices to access a service provider network via the residential gateway.

In another particular embodiment, a method includes receiving, at a residential gateway, an authentication request from a set-top box device to authenticate the set-top box device to access a service provider network via the residential gateway. The method includes accessing data records stored at a memory of the residential gateway. The method also includes determining that at least one of the data records includes authentication data associated with the set-top box device. The method also includes determining, at the residential gateway, whether the set-top box device has an authenticated status based at least partially on the authentication data. The method also includes enabling the set-top box device to access the service provider network when the set-top box device has the authenticated status.

In another particular embodiment, a computer-readable storage medium includes operational instructions that, when executed by a processor, cause the processor to receive, at a residential gateway, an authentication request from a set-top box device. The computer-readable storage medium includes operational instructions that, when executed by the processor, cause the processor to access authentication data stored at a memory of the residential gateway. The authentication data is associated with the set-top box device. The computer-readable storage medium includes operational instructions that, when executed by the processor, cause the processor to authenticate the set-top box device at the residential gateway based at least partially on the authentication data.

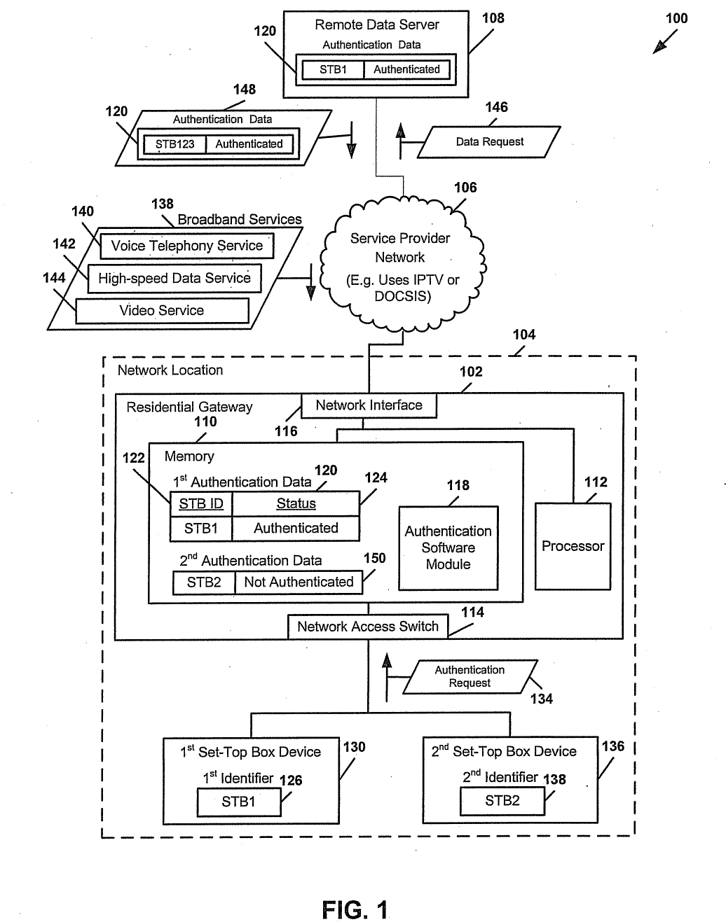

Referring to FIG. 1, a block diagram of a first particular embodiment of a system to authenticate a set-top box device is depicted and generally designated 100. The system 100 includes a residential gateway 102 at a network location 104 coupled to a remote data server 108 via a service provider network 106. The system 100 enables a set-top box device at the network location 104 to be authenticated at the residential gateway 102.

The residential gateway 102 includes a memory 110, a processor 112, a network access switch 114, and a network interface 116. The memory 110 includes an authentication software module 118, first authentication data 120 and second authentication data 150. In a particular embodiment, the memory 110 includes non-volatile memory.

A first set-top box device 130 and a second set-top box device 136 are coupled to the residential gateway 102 at the network location 104. The first authentication data 120 is associated with the first set-top box device 130 and includes an STB ID data record 122 and a status data record 124. The second authentication data 150 is associated with the second set-top box device 136. The first authentication data 120 is stored at the memory 110 of the residential gateway 102 to enable the residential gateway 102 to authenticate the first set-top box devices 130. The second authentication data 150 is stored at the residential gateway 102 to enable the residential gateway 102 to authenticate the second set-top box devices 136. The residential gateway 102 is configured to authenticate the set-top box devices 130 and 136 at the network location 104 using the first authentication data 120 stored at the memory 110 of the residential gateway 102. The residential gateway 102 is configured to enable the set-top box devices 130 and 136 at the network location 104 to access the service provider network 106 when the residential gateway 102 authenticates the set-top box device. In a particular embodiment, the residential gateway 102 instructs the network access switch 114 to enable a set-top box device at the network location 104 to access the service provider network 106.

The first set-top box device 130 has a first identifier 126. The second set-top box device 136 has a second identifier 138. The set-top box devices 130 and 136 are configured to access the service provider network 106 when the set-top box devices 130 and 136 have been authenticated by the residential gateway 102. The residential gateway 102 may authenticate the first set-top box device 130 based at least partially on the first identifier 126 and may authenticate the second set-top box device 136 based at least partially on the second identifier 138.

The service provider network 106 is configured to provide one or more broadband services 138 to the set-top box devices 130 and 136 via the residential gateway 102. In a particular embodiment, the broadband services 138 include a voice telephony service 140, a high speed data service 142, a video service 144, other broadband service, or any combination thereof. In a particular embodiment, the service provider network 106 uses an Internet Protocol Television (IPTV) protocol. In another particular embodiment, the service provider network 106 uses a data-over-cable service interface specification (DOCSIS) protocol.

The remote data server 108 includes the first authentication data 120. The remote data server 108 is configured to send the first authentication data 120 to the residential gateway 102. The first set-top box device 130 is configured to access broadband services 138 of the service provider network 106 via the residential gateway 102 when the first set-top box device 130 is authenticated by the residential gateway 102.

In operation, the residential gateway 102 receives the first authentication data 120 from the remote date server 108 and stores the first authentication data 120 at the memory 110 of the residential gateway 102. In a particular embodiment, the first authentication data 120 is received by the residential gateway 102 in response to the residential gateway 102 sending a data request 146 to the remote data server 108. In another particular embodiment, the first authentication data 120 is received at the residential gateway 102 in response to the remote data server 108 determining that the residential gateway 102 is coupled to the service provider network 106. In a particular embodiment, the first authentication data 120 is encrypted before the first authentication data 120 is stored at the memory 110 of the residential gateway 102. For example, the first authentication data 120 may be encrypted and stored at a non-volatile portion of the memory 110.

The residential gateway 102 receives an authentication request 134 from a set-top box device, such as the first set-top box device 130. For example, the authentication request 134 may be sent by the first set-top box device 130 after the first set-top box device 130 is rebooted. The residential gateway 102 identifies a data record, such as the first authentication data 120, stored at the memory 110 based on the authentication request 134. For example, the residential gateway 102 may access the first authentication data 120 stored at the memory 110 to authenticate the first set-top box device 130. The residential gateway 102 authenticates the first set-top box device 130 at the residential gateway 102 based at least partially on the first authentication data 120. After the first set-top box device 130 is authenticated, the residential gateway 102 enables the first set-top box device 130 to access the service provider network 106 via the residential gateway 104. For example, the residential gateway 102 may instruct the network access switch 114 to enable the first set-top box device 130 to access one or more of the broadband services 138 of the service provider network 106.

When the residential gateway 102 receives the authentication request 134 from the second set-top box device 136, the residential gateway 102 determines that the second set-top box device 136 is not authorized to access the service provider network 106 based at least partially on the second authentication data 150. The residential gateway 102 denies the second set-top box device 136 access to the service provider network 106 after the residential gateway 102 determines that the second set-top box device 136 is not authorized to access the service provider network 106. For example, the residential gateway 102 may instruct the network access switch 114 to deny the second set-top box device 136 access to the service provider network 106.

By storing the first authentication data 120 at the memory 110 of the residential gateway 102, the residential gateway 102 is enabled to authenticate the first set-top box device 130 and the second set-top box device 136 at the network location 104. The residential gateway 102 takes less time to authenticate the first set-top box device 130 and the second set-top box device 136 than the remote data server 108 because of the proximity of the first set-top box device 130 and the second set-top box device 136 to the residential gateway 102. In contrast to the residential gateway 102, the remote data server 108 is remote from the network location 104. By authenticating the set-top box devices 130 and 136 at the network location 104 instead of at the remote data server 108, delays that may result from high traffic volume at the service provider network 106 are reduced. When multiple set-top box device at a particular service area reboot due to a power outage or a software upgrade, the residential gateways at each of the network locations are capable of authenticating the set-top box devices at that network location, thus reducing messaging to and from the remote data server 108.

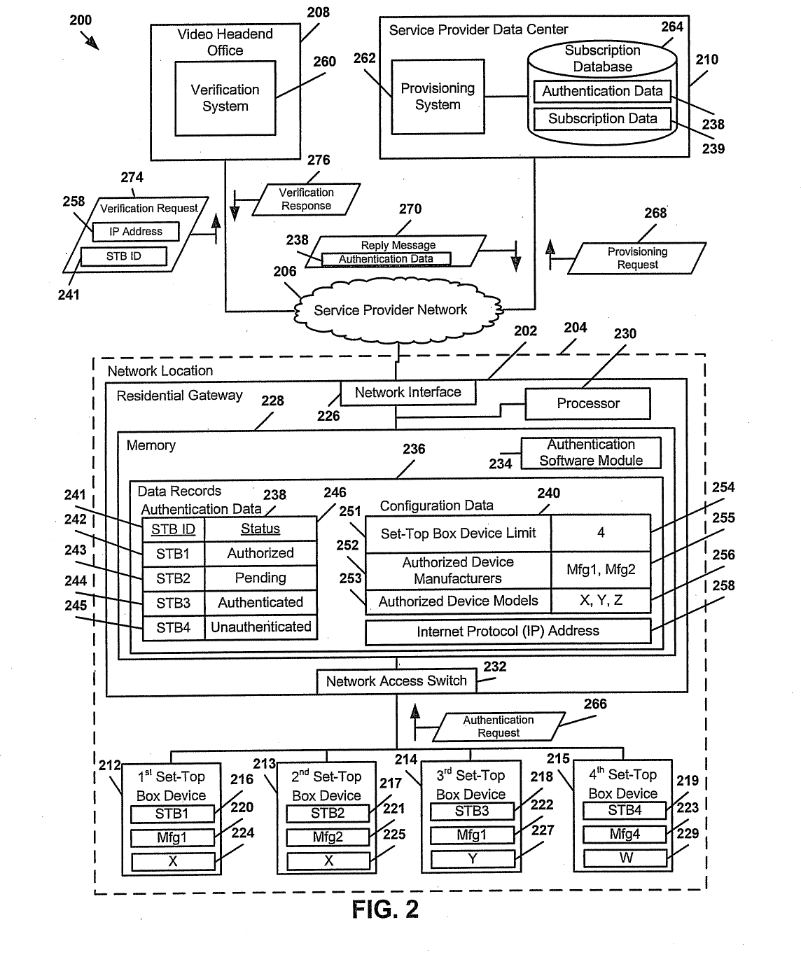

Referring to FIG. 2, a block diagram of a second particular embodiment of a system to authenticate a set-top box device is depicted and generally designated 200. The system 200 includes a residential gateway 202 coupled to a service provider network 206. A video headend office 208 and a service provider data center 210 are also coupled to the service provider network 206. The system 200 enables one or more set-top box devices at a network location 204 to be authenticated at the residential gateway 202.

In the embodiment shown, a first set-top box device 212, a second set-top box device 213, a third set-top box device 214, and a fourth set-top box device 215 are coupled to the residential gateway 202 at the network location 204. The first set-top box device 212 has a set-top box identifier STB 1 216, a manufacturer Mfg1 220, and a model number X 224. The second set-top box device 213 has a set-top box identifier STB2 217, a manufacturer Mfg2 221, and a model number X 225. The third set-top box device 213 has a set-top box identifier STB3 218, a manufacturer Mfg1 222, and a model number Y 227. The fourth set-top box device 212 has a set-top box identifier STB4 216, a manufacturer Mfg4 223, and a model number W 229. The set-top box devices 212-215 are configured to access the service provider network 206 via the residential gateway 202 after the set-top box devices 212-215 have been authenticated by the residential gateway 202.

The residential gateway 202 includes a network interface 226, a memory 228, a processor 230, and a network access switch 232. The memory 228 includes an authentication software module 234 and data records 236. The data records 236 include authentication data 238, configuration data 240, and an Internet Protocol (IP) address 258. Each entry of the authentication data 238 has a set-top box device identifier (STB ID) 242 and a status 246. The configuration data 240 includes a set-top box limit 251, an authorized device manufacturers 252, and an authorized device models 253. For example, the set-top box limit 251 may identify a maximum number of set-top box devices that may be coupled to the residential gateway 202 at the network location 204. The set-top box device limit 251 may be determined based at least partially on the subscription data 239. The residential gateway 202 is configured to use the data records 236 at the memory 228 to authenticate the set-top box devices 212-215 to enable the set-top box devices 212-215 to access the service provider network 206. In a particular embodiment, the residential gateway 202 instructs the network access switch 232 to enable a set-top box device at the network location 204 to access the service provider network 206.

The video headend office 208 includes a verification system 260. The verification system 260 is configured to verify that the set-top box devices 212-215 have an authorized device manufacturer and an authorized device model to access the IPTV system of the service provider network 206.

The service provider data center 210 includes a service provisioning system 262 and a subscription database 264. The subscription database 264 includes authentication data 238 and subscription data 239. In a particular embodiment, the authentication data 238 is associated with the subscription data 239. The service provider data center 210 is configured to determine whether the set-top box devices 212-215 are authorized to access the service provider network 206 via the residential gateway 202 based on the subscription data 239.

In operation, the residential gateway 202 receives an authentication request 266 from a set-top box device, such as one of the set-top box devices 212-215, to authenticate the set-top box device to access the service provider network 206 via the residential gateway 202. For example, the residential gateway 202 may receive the authentication request 266 when one or more of the set-top box devices 212-215 are rebooted or when one of the set-top box devices 212-215 is coupled to the residential gateway 202. After receiving the authentication request 266, the residential gateway 202 accesses the data records 236 stored at the memory 228 of the residential gateway 202. The residential gateway 202 determines whether one of the data records 236 includes the authentication data 238 associated with one of the set-top box devices 212-215 based at least partially on the authentication request 266. The residential gateway 202 determines whether a set-top box device that sent the authentication request 266 has an authenticated status based at least partially on the authentication data 238 of the data records 236. The residential gateway 202 enables a set-top box device that sent the authentication request 266 to access the service provider network 206 when the set-top box device has an authenticated status.

The residential gateway 202 denies a set-top box device that sent the authentication request 266 access to the service provider network 206 when the set-top box device has an unauthenticated status. In a particular embodiment, the residential gateway 202 determines that a set-top box device has an unauthenticated status by determining that authenticating the set-top box device would exceed the set-top box device limit 251 stored at the residential gateway 202. For example, when the set-top box device limit 251 is four, adding a fifth set-top box device (not shown) would exceed the set-top box device limit 251, so the residential gateway 202 denies the fifth set-top box device access to the service provider network 206. In a particular embodiment, the residential gateway 202 determines that the set-top box device has an unauthenticated status by determining that a manufacturer of the set-top box device is not included in the authorized device manufacturers 252. For example, the residential gateway 202 determines that the manufacturer W 229 of the fourth set-top box device 215 is not in the authorized device manufacturers 252 and denies the fourth set-top box device 215 access to the service provider network 206. In a particular embodiment, the residential gateway 202 determines that the set-top box device has the unauthenticated status by determining that an authorized device models 253 does not include a device model of the set-top box device. For example, when the residential gateway 202 determines that the authorized device models 256 does not include the device model Mfg4 223 of the fourth set-top box device 215, the residential gateway 202 denies the fourth set-top box device 215 access to the service provider network 206.

When the residential gateway 202 determines that the data records 236 do not include a data record corresponding to one of the set-top box devices 212-215 that sent the authentication request 266, the residential gateway 202 sends a provisioning request 268 to the provisioning system 262. For example, the data records 236 may not have a data record associated with the first set-top box device 212 when the first set-top box device 212 is initially coupled to the residential gateway 202. After receiving the provisioning request 268, the service provider data center 210 determines whether the subscription database 264 has the subscription data 239 authorizing the first set-top box device 212 to access the service provider network 206 via the residential gateway 202. The service provider data center 210 sends a reply message 270 to the residential gateway 202. When the service provider data center 210 determines that the subscription database 264 has the subscription data 239 authorizing the first set-top box device 212 to access the service provider network 206 via the residential gateway 202, the reply message 270 includes the authentication data 238.

The residential gateway 202 receives the reply message 270 from the service provider data center 210. The residential gateway 202 adds the data record 242 to the data records 236 of the residential gateway 202. The added data record 242 is associated with the first set-top box device 212 that sent the authentication request 266. When the reply message 270 indicates that the subscription data 239 authorizes the first set-top box device 212 to access the service provider network 206 via the residential gateway 202, the residential gateway 202 modifies the data record 242 associated with the first set-top box device 212 to include the authorized status. The residential gateway 202 stores the authentication data 238 at the memory 228 to enable the residential gateway 202 to authenticate the first set-top box device 212. When the reply message 270 does not include the authentication data 238, the residential gateway 202 modifies the added data record, such as the data record 245, to include the unauthenticated status. For example, when the reply message 270 does not include the authentication data 238 associated with the fourth set-top box device 215, the residential gateway 202 modifies the data record 245 to include the unauthenticated status.

When the residential gateway determines that a data record associated with a set-top box device includes the authorized status, the residential gateway 202 (i) sends a verification request 274 to determine whether the set-top box device is compatible with the service provider network 206 and (ii) modifies the data record associated with the set-top box device from the authorized status to a pending status. For example, after the residential gateway 202 receives the reply message 270 and modifies the data record 243 associated with the second set-top box device 213 to include the authorized status, the residential gateway 202 sends the verification request 274 and modifies the data record 243 associated with the second set-top box device 213 to a pending status. In a particular embodiment, the verification request 274 includes the IP address 258 of the residential gateway 202 and the STB ID 241 of one of the set-top box devices 212-215. For example, the verification request 274 may include the set-top box device identifier STB2 of the second set-top box device 213. The verification system 260 determines whether a set-top box device, such as the second set-top box device 213, is compatible with the service provider network 206 and sends a verification response 276 indicating whether the set-top box device is compatible with the service provider network 206.

When the verification response 276 indicates that the second set-top box device 213 is compatible with the service provider network 206, the residential gateway 202 modifies the data record 243 associated with the second set-top box device 213 from the pending status to an authenticated status. For example, in the embodiment shown, the data record 244 indicates that the third set-top box device 214 has an authenticated status.

When the verification system 260 indicates that a set-top box device is incompatible with the service provider network 206, the residential gateway 202 modifies the data record associated with the set-top box device from the pending status to the unauthenticated status. For example, when the verification system 260 indicates that the fourth set-top box device 215 is incompatible with the service provider network 206, the residential gateway 202 modifies the data record 245 associated with the fourth set-top box device 215 from the pending status to the unauthenticated status.

By storing the authentication data 238 at the memory 228 of the residential gateway 202, the residential gateway 202 can authenticate the set-top box devices 212-215 at the network location 104. The service provider data center 210 receives the provisioning request 268 from the residential gateway 202 when one of the set-top box devices 212-25 is initially coupled to the residential gateway 202. After the residential gateway 202 receives the authentication data 238 from the service provider data center 210, the residential gateway 202 stores the authentication data at the memory 228 to enable the residential gateway 202 to authenticate the set-top box device 212-215. By storing the authentication data 238 at the memory 228 after a set-top box device is initially coupled to the residential gateway 202, the residential gateway 202 authenticates the set-top box devices 212-215 at the network location 204 instead of at the remote data server 108. When the set-top box devices 212-215 reboot due to a power outage or a software upgrade, the residential gateway 202 authenticates the set-top box devices 212-215 at the network location 204, thereby reducing messaging to and from the remote data server 108.

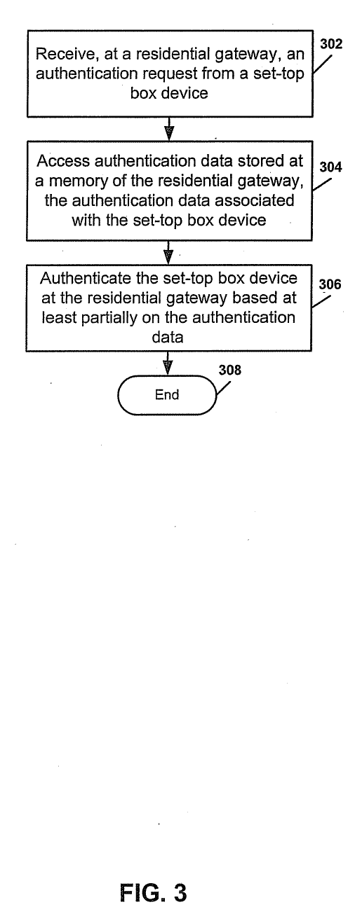

FIG. 3 is a flow diagram of a first particular embodiment of a method to authenticate a set-top box device. The method may be performed by the residential gateway 102 of FIG. 1 or the residential gateway 202 of FIG. 2.

The method includes receiving an authentication request from a set-top box device at a residential gateway, at 302. For example, in FIG. 1, the residential gateway 102 receives the authentication request 134 from the first set-top box device 130 or the second set-top box device 136. Moving to 304, authentication data stored at a memory of the residential gateway is accessed. The authentication data is associated with the set-top box device. For example, in FIG. 1, the residential gateway 102 may access the first authentication data 120 associated with the first set-top box device 130 stored at the memory 110. Continuing to 306, the set-top box device is authenticated at the residential gateway based at least partially on the authentication data. For example, in FIG. 1, the residential gateway 102 authenticates the first set-top box device 130 at the residential gateway 102 based at least partially on the first authentication data 120. The method ends at 308. Thus, by storing authentication data at a memory of a residential gateway, the residential gateway can authenticate set-top box devices at a network location of the residential gateway. The residential gateway is able to authenticate the set-top box devices at the network location of the residential gateway faster than a remote data server because the residential gateway is not remote from the set-top box devices and because the residential gateway has fewer set-top box devices to authenticate than a remote data server serving multiple residential gateways at multiple locations.

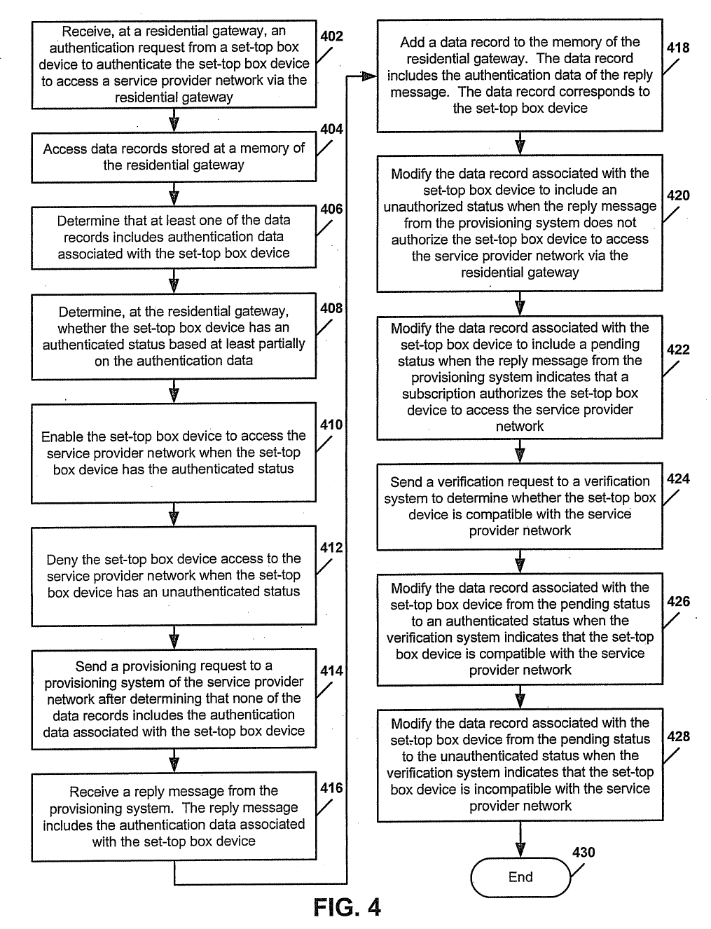

FIG. 4 is a flow diagram of a second particular embodiment of a method to authenticate a set-top box device. The method may be performed by a residential gateway such as the residential gateway 202 of FIG. 2.

An authentication request is received at a residential gateway from a set-top box device to authenticate the set-top box device to access a service provider network via the residential gateway, at 402. Moving to 404, data records stored at a memory of the residential gateway are accessed. For example, in FIG. 2, the residential gateway 202 receives the authentication request 266 from one of the set-top box devices 212-215 and accesses the data records 236 stored at the memory 228 of the residential gateway 202. Continuing to 406, a determination is made that at least one of the data records includes authentication data associated with a set-top box device. For example, in FIG. 2, the data records 236 are accessed to determine whether one of the data records 236 includes the authentication data 238 associated with a set-top box device that sent the authentication request 266. Advancing to 408, a determination is made, at the residential gateway, that the set-top box device has an authenticated status based at least partially on the authentication data. For example, in FIG. 2, the residential gateway 202 accesses the authentication data 238 and determines an authentication status based on the authentication data 238. Continuing to 410, the set-top box device is enabled to access the service provider network when the set-top box device has the authenticated status. For example, in FIG. 2, when the residential gateway 202 determines that the third set-top box device 214 has an authenticated status, the residential gateway 202 instructs the network access switch 232 to enable the third set-top box device 214 to access the service provider network 206 via the residential gateway 202.

Proceeding to 412, in a particular embodiment, the set-top box device is denied access to the service provider network when the set-top box device has an unauthenticated status. For example, in FIG. 2, when the residential gateway 202 determines that the fourth set-top box device 215 has the unauthenticated status, the residential gateway 202 instructs the network access switch 232 to deny the fourth set-top box device 215 access to the service provider network 206. Advancing to 414, in a particular embodiment, a provisioning request is sent to a provisioning system of the service provider network after determining that none of the data records includes the authentication data associated with the set-top box device. For example, in FIG. 2, the residential gateway 202 sends the provisioning request 268 to the provisioning system 262 after determining that none of the data records 236 includes authentication data associated with a set-top box device. Proceeding to 416, in a particular embodiment, the method includes receiving a reply message from the provisioning system. The reply message includes the authentication data associated with the set-top box device. For example, in FIG. 2, the reply message 270, including the authentication data 238, is received from the provisioning system 262.

Continuing to 418, in a particular embodiment, a data record is added to the memory of the residential gateway. The data record includes the authentication data of the reply message. For example, in FIG. 2, the residential gateway 202 may add a data record to the data records 236 and the added data record may include the authentication data 238 corresponding to a set-top box device. Moving to 420, in a particular embodiment, the data record associated with the set-top box device is modified to include an unauthenticated status when the reply message from the provisioning system does not authorize the set-top box device to access the service provider network. For example, in FIG. 2, the data record 245 associated with the fourth set-top box device 215 is modified to include the unauthenticated status when the reply message 270 does not authorize the fourth set-top box device 215 to access the service provider network 206 via the residential gateway 202. Proceeding to 422, in a particular embodiment, the data record associated with the set-top box device is modified to include a pending status when the reply message from the provisioning system indicates that a subscription authorizes the set-top box device to access the service provider network. Advancing to 424, in a particular embodiment, a verification request is sent to a verification system to determine whether the set-top box device is compatible with the service provider network. For example, in FIG. 2, the residential gateway 202 sends the verification request 274 to the verification system 260 of the video headend office 208 to determine whether a set-top box device is compatible with the service provider network 206. Moving to 426, in a particular embodiment, the data record associated with the set-top box device is modified from the pending status to an authenticated status when the verification system indicates that the set-top box device is compatible with the service provider network. For example, in FIG. 2, the residential gateway 202 modifies the data record 244 to the authenticated status when the verification response 276 indicates that the third set-top box device 214 is compatible with the service provider network 206. Continuing to 428, in a particular embodiment, the data record associated with the set-top box device is modified from the pending status to the unauthenticated status when the verification system indicates that the set-top box device is incompatible with the service provider network. For example, in FIG. 2, the residential gateway 202 modifies the data record 245 to the unauthenticated status when the verification response 276 indicates that the fourth set-top box device 215 is incompatible with the service provider network 206. The method ends at 430.

Thus, when an STB is initially coupled to a residential gateway and requests authentication, the residential gateway receives authentication data from a service provider data center and stores the authentication data at a memory of the residential gateway. After storing the authentication data, the residential gateway authenticates the set-top box device without involving the service provider data center, thereby reducing messaging to and from the service provider data center.

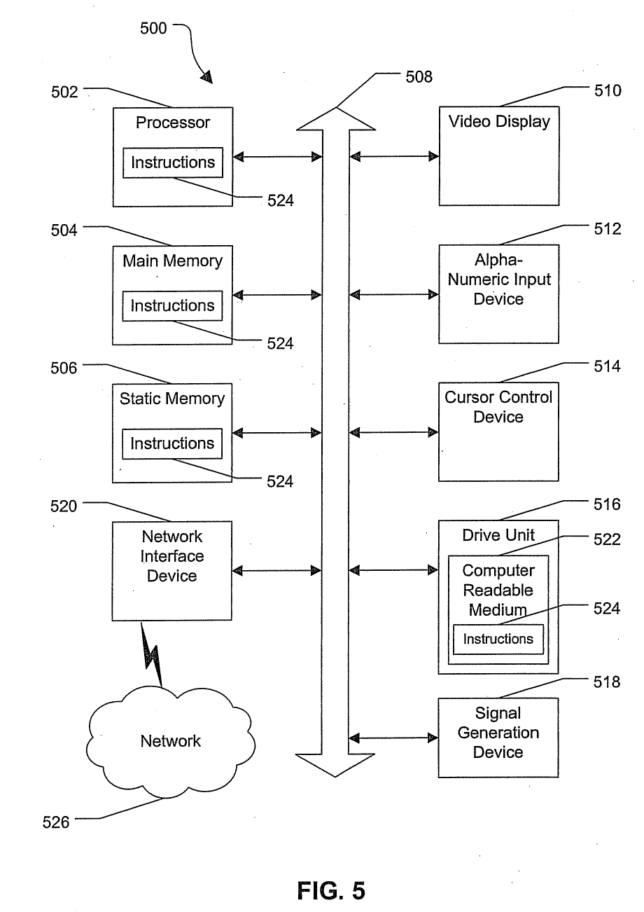

Referring to FIG. 5, an illustrative embodiment of a general computer system is shown and is designated 500. The computer system 500 can include a set of instructions that can be executed to cause the computer system 500 to perform any one or more of the methods or computer based functions disclosed herein. The computer system 500, or any portion thereof, may operate as a standalone device or may be connected, e.g., using a network, to other computer systems or peripheral devices, including a media content server or a set-top box device, as shown in FIG. 1 and FIG. 2.

In a networked deployment, the computer system may operate in the capacity of a server, such as a video server or application server, or a set-top box device. The computer system 500 can also be implemented as or incorporated into various devices, such as a personal computer (PC), a tablet PC, a set-top box (STB) device, a personal digital assistant (PDA), a mobile device, a palmtop computer, a laptop computer, a desktop computer, a communications device, a wireless telephone, a land-line telephone, a control system, a camera, a scanner, a facsimile machine, a printer, a pager, a personal trusted device, a web appliance, a network router, switch or bridge, or any other machine capable of executing a set of instructions (sequential or otherwise) that specify actions to be taken by that machine. In a particular embodiment, the computer system 500 can be implemented using electronic devices that provide voice, video or data communication. Further, while a single computer system 500 is illustrated, the term “system” shall also be taken to include any collection of systems or sub-systems that individually or jointly execute a set, or multiple sets, of instructions to perform one or more computer functions.

As illustrated in FIG. 5, the computer system 500 may include a processor 502, e.g., a central processing unit (CPU), a graphics-processing unit (GPU), or both. Moreover, the computer system 500 can include a main memory 504 and a static memory 506 that can communicate with each other via a bus 508. As shown, the computer system 500 may further include a video display unit 510, such as a liquid crystal display (LCD), an organic light emitting diode (OLED), a flat panel display, a solid-state display, or a cathode ray tube (CRT). Additionally, the computer system 500 may include an input device 512, such as a keyboard, and a cursor control device 514, such as a mouse. The computer system 500 can also include a disk drive unit 516, a signal generation device 518, such as a speaker or remote control, and a network interface device 520.

In a particular embodiment, as depicted in FIG. 5, the disk drive unit 516 may include a computer-readable medium 522 in which one or more sets of instructions 524, e.g. software, can be embedded. Further, the instructions 524 may embody one or more of the methods or logic as described herein. In a particular embodiment, the instructions 524 may reside completely, or at least partially, within the main memory 504, the static memory 506, and/or within the processor 502 during execution by the computer system 500. The main memory 504 and the processor 502 also may include computer-readable media.

In an alternative embodiment, dedicated hardware implementations, such as application specific integrated circuits, programmable logic arrays and other hardware devices, can be constructed to implement one or more of the methods described herein. Applications that may include the apparatus and systems of various embodiments can broadly include a variety of electronic and computer systems. One or more embodiments described herein may implement functions using two or more specific interconnected hardware modules or devices with related control and data signals that can be communicated between and through the modules, or as portions of an application-specific integrated circuit. Accordingly, the present system encompasses software, firmware, and hardware implementations.

In accordance with various embodiments of the present disclosure, the methods described herein may be implemented by software programs executable by a computer system. Further, in an exemplary, non-limited embodiment, implementations can include distributed processing, component/object distributed processing, and parallel processing. Alternatively, virtual computer system processing can be constructed to implement one or more of the methods or functionality as described herein.

The present disclosure contemplates a computer-readable medium that includes instructions 524 or receives and executes instructions 524 responsive to a propagated signal, so that a device connected to a network 526 can communicate voice, video or data over the network 526. Further, the instructions 524 may be transmitted or received over the network 526 via the network interface device 520.

While the computer-readable medium is shown to be a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the methods or operations disclosed herein.

In a particular non-limiting, exemplary embodiment, the computer-readable medium can include a solid-state memory such as a memory card or other package that houses one or more non-volatile read-only memories. Further, the computer-readable medium can be a random access memory or other volatile re-writable memory. Additionally, the computer-readable medium can include a magneto-optical or optical medium, such as a disk or tapes or other storage device to capture carrier wave signals such as a signal communicated over a transmission medium. A digital file attachment to an email or other self-contained information archive or set of archives may be considered a distribution medium that is equivalent to a tangible storage medium. Accordingly, the disclosure is considered to include any one or more of a computer-readable medium or a distribution medium and other equivalents and successor media, in which data or instructions may be stored.

In accordance with various embodiments, the methods described herein may be implemented as one or more software programs running on a computer processor. Dedicated hardware implementations including, but not limited to, application specific integrated circuits, programmable logic arrays and other hardware devices can likewise be constructed to implement the methods described herein. Furthermore, alternative software implementations including, but not limited to, distributed processing or component/object distributed processing, parallel processing, or virtual machine processing can also be constructed to implement the methods described herein.

It should also be noted that software that implements the disclosed methods may optionally be stored on a tangible storage medium, such as: a magnetic medium, such as a disk or tape; a magneto-optical or optical medium, such as a disk; or a solid state medium, such as a memory card or other package that houses one or more read-only (non-volatile) memories, random access memories, or other re-writable (volatile) memories. A digital file attachment to email or other self-contained information archive or set of archives is considered equivalent to a tangible storage medium. Accordingly, the disclosure is considered to include a tangible storage medium, and other equivalents and successor media, in which the software implementations herein may be stored.

Although the present specification describes components and functions that may be implemented in particular embodiments with reference to particular standards and protocols, the invention is not limited to such standards and protocols. For example, standards for Internet and other packet switched network transmission (e.g., TCP/IP, UDP/IP, HTML, HTTP) represent examples of the state of the art. Standards for video transmission include IPTV, DOCSIS, and H.264 as well as standards promulgated by the Motion Picture Experts Group (MPEG), and the Society of Motion Picture and Television Engineers (SMPTE). Such standards are periodically superseded by faster or more efficient equivalents having essentially the same functions. Accordingly, replacement standards and protocols having the same or similar functions as those disclosed herein are considered equivalents thereof.

The illustrations of the embodiments described herein are intended to provide a general understanding of the structure of the various embodiments. The illustrations are not intended to serve as a complete description of all of the elements and features of apparatus and systems that utilize the structures or methods described herein. Many other embodiments can be apparent to those of skill in the art upon reviewing the disclosure. Other embodiments can be utilized and derived from the disclosure, such that structural and logical substitutions and changes can be made without departing from the scope of the disclosure. Additionally, the illustrations are merely representational and can not be drawn to scale. Certain proportions within the illustrations can be exaggerated, while other proportions can be minimized. Accordingly, the disclosure and the figures are to be regarded as illustrative rather than restrictive.

One or more embodiments of the disclosure can be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose can be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract of the Disclosure is provided with the understanding that it will not be used to interpret or limit the scope or meaning of the claims. In addition, in the foregoing Detailed Description, various features can be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter can be directed to less than all of the features of any of the disclosed embodiments. Thus, the following claims are incorporated into the Detailed Description, with each claim standing on its own as defining separately claimed subject matter.

The above-disclosed subject matter is to be considered illustrative, and not restrictive, and the appended claims are intended to cover all such modifications, enhancements, and other embodiments that fall within the true scope of the present invention. Thus, to the maximum extent allowed by law, the scope of the present invention is to be determined by the broadest permissible interpretation of the following claims and their equivalents, and shall not be restricted or limited by the foregoing detailed description.

What is claimed is:

1. A computer-readable storage medium comprising operational instructions that, when executed by a processor, cause the processor to:
receive, at a residential gateway, an authentication request from a set-top box device;
access authentication data stored at a memory of the residential gateway, the authentication data associated with the set-top box device; and
authenticate the set-top box device at the residential gateway based at least partially on the authentication data.

2. The computer-readable storage medium of claim 1, further comprising operational instructions that, when executed by the processor, cause the processor to enable the set-top box device to access a service provider network via the residential gateway after the set-top box device is authenticated.

3. The computer-readable storage medium of claim 1, further comprising operational instructions that, when executed by the processor, cause the processor to:
receive the authentication data at the residential gateway from a remote data server; and
store the authentication data at the memory of the residential gateway.

4. The computer-readable storage medium of claim 3, further comprising operational instructions that, when executed by the processor, cause the processor to receive the authentication data in response to sending a data request from the residential gateway to the remote data server.

5. The computer-readable storage medium of claim 3, further comprising operational instructions that, when executed by the processor, cause the processor to receive the authentication data in response to the remote data server determining that the residential gateway has access to the service provider network.

6. The computer-readable storage medium of claim 3, wherein the authentication data is encrypted before the authentication data is stored at the memory.

7. The computer-readable storage medium of claim 1, wherein the memory includes non-volatile memory.

8. The computer-readable storage medium of claim 1, further comprising operational instructions that, when executed by the processor, cause the processor to:
determine, at the residential gateway, that a second set-top box device is not authorized to access the service provider network based at least partially on second authentication data stored at the residential gateway; and
deny the second set-top box device access to the service provider network.

9. A system comprising:
a service provisioning system to send authentication data to a residential gateway, the authentication data to be stored at the residential gateway to enable the residential gateway to authenticate one or more set-top box devices associated with the residential gateway; and
wherein authenticating the one or more set-top box devices enables the one or more set-top box devices to access a service provider network via the residential gateway.

10. The system of claim 9, wherein the service provider network is capable of providing at least one of a voice telephony service, a high-speed data service, and a video service via the residential gateway.

11. The system of claim 9, wherein the service provider network uses an Internet Protocol Television (IPTV) protocol.

12. The system of claim 9, wherein the service provider network uses a Data Over Cable Service Interface Specification (DOCSIS) protocol.

13. A method, comprising:
receiving, at a residential gateway, an authentication request from a set-top box device to authenticate the set-top box device to access a service provider network via the residential gateway;
accessing data records stored at a memory of the residential gateway;
determining that at least one of the data records includes authentication data associated with the set-top box device;
determining, at the residential gateway, whether the set-top box device has an authenticated status based at least partially on the authentication data; and
enabling the set-top box device to access the service provider network when the set-top box device has the authenticated status.

14. The method of claim 13, further comprising denying the set-top box device access to the service provider network when the set-top box device has an unauthenticated status.

15. The method of claim 14, wherein determining whether the set-top box device has the unauthenticated status comprises determining whether authenticating the set-top box device would exceed a subscription-based set-top box limit stored at the residential gateway.

16. The method of claim 14, wherein determining whether the set-top box device has the unauthenticated status comprises determining whether a data record of authorized device manufacturers does not include a manufacturer of the set-top box device.

17. The method of claim 14, wherein determining whether the set-top box device has the unauthenticated status comprises determining whether a data record of authorized device models does not include a device model of the set-top box device.

18. The method of claim 13, further comprising:
sending a provisioning request to a provisioning system of the service provider network after determining that none of the data records includes the authentication data associated with the set-top box device; and
receiving a reply message from the provisioning system, wherein the reply message includes the authentication data associated with the set-top box device.

19. The method of claim 18, further comprising adding a data record to the memory of the residential gateway, the data record including the authentication data of the reply message, wherein the data record corresponds to the set-top box device.

20. The method of claim 13, wherein determining whether the set-top box device has the authenticated status comprises:
determining that at least one of the data records includes the authentication data associated with the set-top box device; and
determining an authorization status of the set-top box device based at least partially on the authentication data.

21. The method of claim 20, further comprising modifying the data record associated with the set-top box device to include an unauthorized status when the reply message from the provisioning system does not authorize the set-top box device to access the service provider network via the residential gateway.

22. The method of claim 21, further comprising modifying the data record associated with the set-top box device to include an authorized status when the reply message from the provisioning system indicates that a subscription authorizes the set-top box device to access the service provider network via the residential gateway.

23. The method of claim 22, further comprising:
modifying the data record associated with the set-top box device to include a pending status; and
sending a verification request to a verification system to determine whether the set-top box device is compatible with the service provider network.

24. The method of claim 22, further comprising modifying the data record associated with the set-top box device from the pending status to an authenticated status when the verification system indicates that the set-top box device is compatible with the service provider network.

25. The method of claim 22, further comprising modifying the data record associated with the set-top box device from the pending status to the unauthorized status when the verification system indicates that the set-top box device is incompatible with the service provider network.
